(19) United States
(12) Patent Application Publication
(10) Pub. No.: US 2025/0040757 A1
(43) Pub. Date: Feb. 6, 2025

(54) FOLDING MECHANISM FOR A PORTABLE PRODUCT

(71) Applicant: The Coleman Company, Inc., Wichita, KS (US)

(72) Inventors: Adam Luedke, Grand Rapids, MI (US); Lucas Eck, Garden Plain, KS (US); Isaiah Gross, Haven, KS (US)

(21) Appl. No.: 18/717,559

(22) PCT Filed: Dec. 9, 2022
(86) PCT No.: PCT/US22/81231

§ 371 Date: Jun. 7, 2024

Related U.S. Application Data
(60) Provisional application No. 63/287,861, filed on Dec. 9, 2021.

(51) Int. Cl. A47J 37/07

(52) U.S. Cl. CPC A47J 37/0763; A47J 37/0713; A47J 2037/0777

(57) ABSTRACT

A folding mechanism for a portable product includes a product support frame. a first set of legs. and a second set of legs. The first set of legs and second set of legs may be pivotably connected with the product support frame and with each other. The second set of legs may further comprise upper folding leg portions and lower folding leg portions pivotably connected with one another. The pivotable connections may allow for rotation of the product support frame. the first set of legs. the upper folding leg portions. and the lower folding leg portions when the folding mechanism is folded and unfolded. When unfolding the folding mechanism. over-rotation stops may prevent rotation of the upper folding leg portions and lower folding leg portions once the folding mechanism reaches an unfolded position. The over-rotation stops may be flanges positioned and located on the upper folding leg portions.

### CROSS-REFERENCE TO RELATED APPLICATIONS

This Application claims priority to U.S. Provisional Patent Application Ser. No. 63/287,861, filed on Dec. 9, 2021, entitled “FOLDING MECHANISM FOR A PORTABLE PRODUCT,” currently pending, the entire disclosure of which is hereby incorporated by reference.

### FIELD OF THE INVENTION

The present disclosure is directed to support frames for products that may be transportable for use in different locations and, more particularly, to a folding support frame with improved ergonomics and ease of use.

### BACKGROUND OF THE INVENTION

There are various consumer and professional products, such as grills and power tools, that are intended to be transportable for use at various locations. For example, barbecue grills may be designed to be used both at home and at athletic events, camp sites, or family gatherings at parks. Similarly, contractors or craftsman may move heavy power tools, such as table saws or lathes, from job site to job site. When using various transportable consumer and professional products, the user may need to rapidly set the products up for use with very few options for stable bases.

There are frames made intended to facilitate the transportability and set up of these products. Some of these frames have the ability to transform from an unfolded position (in which the product may be used) to a folded position (which is useful for transportation and compact storage). However, these frames generally require a user to stoop, bend, or kneel to reach a handle or other device in order to fold or unfold the frame. This is a less than desirable ergonomic relationship due to the required movements which may be difficult for users that experience back or joint issues.

Therefore, there is a need for an improved support frame for portable products that provides improved ergonomics and ease of use.

### BRIEF SUMMARY OF THE INVENTION

A folding support mechanism for a portable product is provided. The folding support mechanism may include a product support frame, a first set of legs, and a second set of legs. The first set of legs and the second set of legs may each be pivotably connected with the product support frame and with each other. The second set of legs may include upper folding leg portions and lower folding leg portions which are pivotably connected with one another. When using the portable product, the user may place the folding support mechanism in an unfolded position. When storing or transporting the portable product, the user may place the folding support mechanism in a folded position. When transforming the folding support mechanism from the folded position to the unfolded position, flanges on at least one of the upper folding leg portions or the lower folding leg portions may prevent over-rotation of the upper folding leg portions relative to the lower folding leg portions.

This aspect is merely illustrative of the innumerable aspects associated with the present disclosure and should not be deemed as limiting in any manner. This and other aspects, features and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the disclosure and wherein similar reference characters indicate the same parts throughout the views.

FIG. 1 is a perspective view of a portable grill with a folding support mechanism in an unfolded position according to a first embodiment of the present disclosure:

FIG. 2 is a perspective view of the portable grill of FIG. 1 with the folding support mechanism in the unfolded position and with a lid in an open position:

FIG. 3 is a perspective view of the portable grill of FIG. 1 with the folding support

mechanism in a folded position:

FIG. 4 is a perspective view of the folding support mechanism of FIG. 1 in the unfolded position:

FIG. 5 is a perspective view of the folding support mechanism of FIG. 1 in a partially folded position:

FIG. 6 is a perspective view of the folding support mechanism of FIG. 1 in the folded position:

FIG. 7 is a front perspective view of a portable grill with a folding support mechanism in an unfolded position according to a second embodiment of the present disclosure:

FIG. 8 is an enlarged view of the portable grill of FIG. 7 with the folding support mechanism in the unfolded position: and

FIG. 9 is a front perspective view of the folding support mechanism of FIG. 7 in the unfolded position.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

The following definitions and non-limiting guidelines must be considered in reviewing the description of the technology set forth herein.

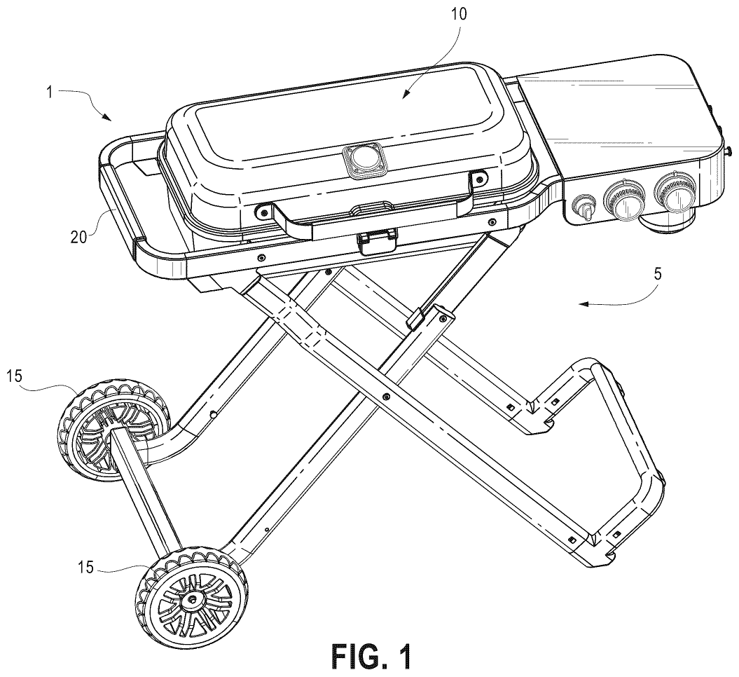

FIG. 1 illustrates a first embodiment of a portable product 1 having a folding support mechanism 5 and a product module 10 mounted thereon. In FIG. 1, the folding support mechanism 5 is in an “unfolded” position. In the unfolded position, the product module 10 may be oriented horizontally at an ergonomic height relative to the ground. In the present embodiment, the product module 10 is a grill module 10. However, the folding support mechanism 5 is suitable for use with any product module 10 for which ready transport and set up is desirable. For example, the folding support mechanism 5 may be used with items such as power tools, furniture, coolers, wagons, tables, grills or other cooking appliances. The product module 10 may be permanently or removably coupled with the folding support mechanism 5. In embodiments where the product module 10 is removably coupled to the folding support mechanism 5, the folding support mechanism 5 may form one component of a modular system in which multiple complementary product modules 10 may be selectively mounted to the folding support mechanism 5.

As further illustrated in FIG. 1, the folding support mechanism 5 may include wheels 15. The folding support mechanism 5 includes two wheels 15, though more or fewer wheels 15 are foreseeable in alternative embodiments. The wheels 15 may assist the user with transporting the portable product 1. For example, a user may grip a handle 20 near the top of the portable product 1 and push (or pull) the portable product 1 horizontally such that the portable product 1 rolls on the wheels 15. The handle 20 may be integrally formed with the folding support mechanism 5 or may be a separate component that is permanently or removably coupled with the folding support mechanism 5.

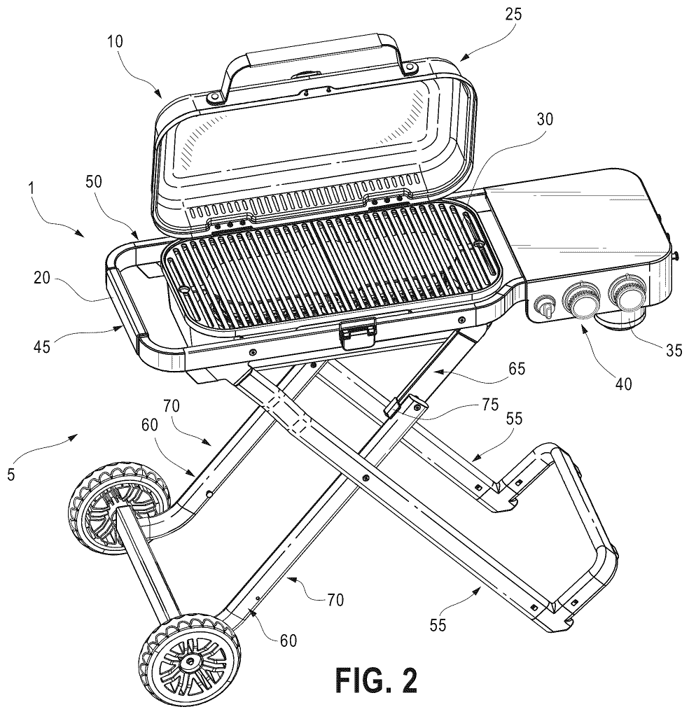

Turning to FIG. 2, the grill module 10 of the portable product 1 may include a lid 25 that is hingedly coupled to the grill module 10. When using the grill module 10, the user may selectively open and close the lid 25 to access a cooking surface 30. Heat for grilling or cooking may be provided to the cooking surface 30 by a burner assembly (not shown) coupled to a fuel source 35. The fuel source 35 may be a 16.4 oz propane tank. However, other fuel sources are foreseeable. The grill module 10 may further include a control module 40 for controlling and regulating the supply of fuel to the burner assembly.

The handle 20 may be positioned and located at a first end 45 of a product support frame 50. The product support frame 50 is a fixed structure on which a product module (such as the grill module 10) may be mounted. The product support frame 50 may be formed from tubular steel or aluminum members with a substantially rectangular cross section. In alternative embodiments, the members of the product support frame 50 may be constructed from other materials (e.g., PVC) and may have any suitable cross-sectional shape. The product support frame 50 is formed generally in a rectangular shape with rounded corners. However, the shape of the product support frame 50 may be configured in any number of shapes to accommodate the product module with which it is being used.

As further illustrated in FIG. 2, a first set of legs 55 and a second set of legs 60 support the folding support mechanism 5. The first set of legs 55 and the second set of legs 60 each include a parallel pair of tubular steel or aluminum members. In alternative embodiments, the first set of legs 55 and the second set of legs 60 may include more or fewer tubular steel or aluminum members. The first set of legs 55 and the second set of legs 60 may also be constructed from other materials (e.g., PVC) and may utilize any suitable cross-sectional shape. The second set of legs 60 may be positioned inwardly between the parallel pair of tubular members of the first set of legs 55. In alternative embodiments, however, the relative inner and outer positions of the first set of legs 55 and the second set of legs 60 may be reversed.

The second set of legs 60 may include upper folding leg portions 65 (only one shown) and lower folding leg portions 70. The upper folding leg portions 65 may be positioned inwardly between the lower folding leg portions 70. As will be described in greater detail below, the upper folding leg portions 65 and the lower folding leg portions 70 may be configured to rotate relative to one another. When the folding support mechanism 5 is in the unfolded position, the upper folding leg portions 65 may extend substantially parallel to the lower folding leg portions 70 along the same direction as the lower folding leg portions 70. Flanges 75 (only one of which is visible in FIG. 2) positioned on the upper folding leg portions 65 may engage with the lower folding leg portions 70 and limit the rotation of the upper folding leg portions 65 relative to the lower folding leg portions 70. Thus, the flanges 75 may act to prevent over-rotation of the leg portions 65, 70 when unfolding the folding support mechanism 5. In alternative embodiments, the folding support mechanism 5 may comprise alternative means for preventing over-rotation. For example, in some embodiments, flanges configured to engage with the upper folding leg portions 65 may be positioned and located on the lower folding leg portions 70. In other embodiments, the folding support mechanism 5 may include one or more crossbars configured to limit over-rotation of the upper folding leg portions 65 relative to the lower folding leg portions 70. In yet other embodiments, the upper folding leg portions 65 and the lower folding leg portions 70 may include complementary cross sections configured to engage with one another.

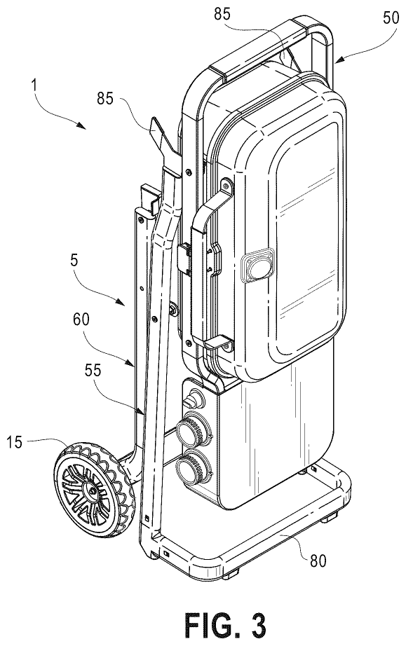

As shown in FIG. 3, the folding support mechanism 5 may be placed in a “folded” position. The folded position allows the user to easily transport or store the portable product 1 in a compact manner. In the folded position, the folding support mechanism 5 may be supported upright in a vertical position by a foot member 80 coupled to the first set of legs 55 of the folding support mechanism 5. In alternative embodiments, the foot member 80 may be coupled to the second set of legs 60. In the illustrated embodiments, the foot member 80 is configured as a U-shaped member. However, other configurations are foreseeable.

Alternatively, the portable product 1 may also be stored laying down on a stable surface (e.g., a truck bed, a floor, etc.) with the folding support mechanism 5 in the folded position. When lying horizontally on a stable surface, standoffs 85 and the wheels 15 may abut the stable surface. Thus, the standoffs 85 and the wheels 15 may support and elevate the folding support mechanism 5. The standoffs 85 may be designed such that when the folding support mechanism 5 is lying horizontally on a stable surface, the standoffs 85 and the wheels 15 elevate the product support frame 50 by a substantially similar amount. As a result, the product support frame 50 may be oriented substantially parallel to the stable surface when lying down horizontally.

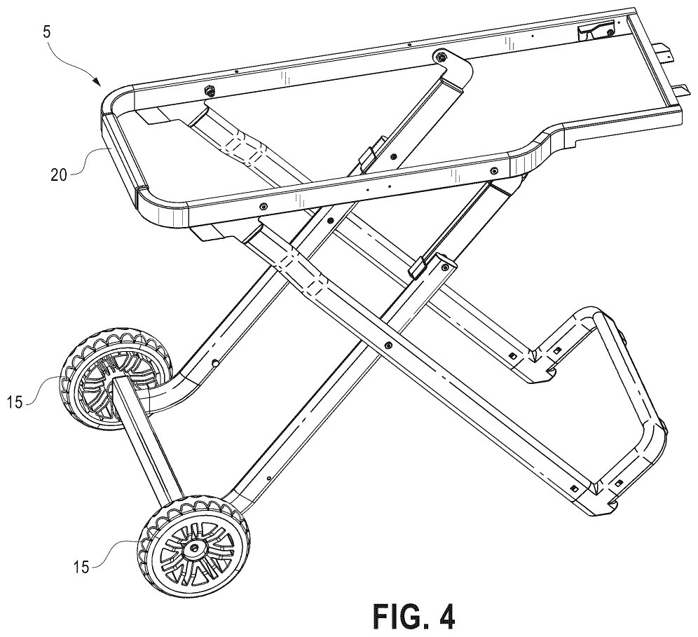

FIGS. 4-6 illustrate the process by which the folding support mechanism 5 is placed into the folded position. Turning first to FIG. 4, a user may begin the process of folding the folding support mechanism 5 by gripping the handle 20 and moving the handle 20 upwardly (i.e., away from the wheels 15).

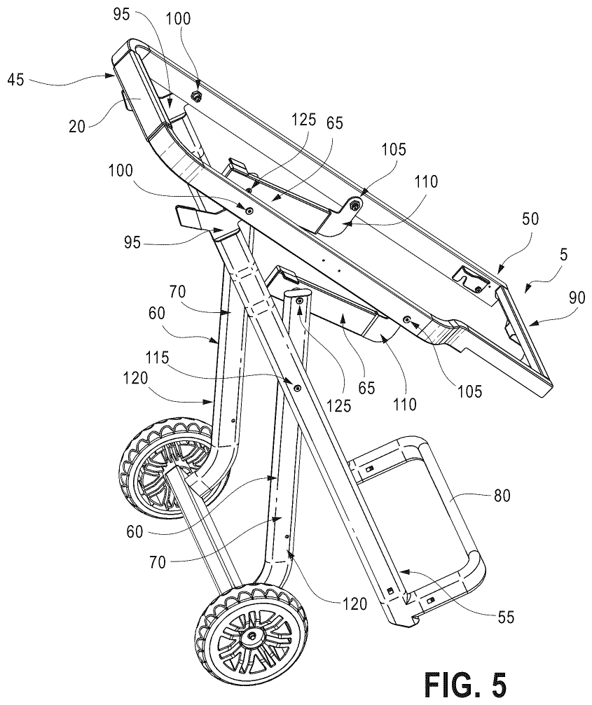

As shown in FIG. 5, as the user moves the handle 20 upwardly, the product support frame 50 will preferably rotate vertically. As a result, the first end 45 of the product support frame 50 may move upwardly, and a second end 90 of the product support frame 50 (opposite from the first end 45) will move downwardly. The rotation of the product support frame 50 may cause the first set of legs 55 to rotate relative to the product support frame 50. More particularly, the first set of legs 55 may rotate towards a vertical orientation, and the foot member 80 (coupled to the first set of legs 55) may move towards the second end 90 of the product support frame 50. To allow such rotation, top portions 95 of the first set of legs 55 may be pivotably coupled to the product support frame 50 using first pivot connections 100. The first pivot connections 100 may be positioned and located proximal to the first end 45 of the product support frame 50 and may be formed by pins, bolts, screws, or other similar connectors.

As the product support frame 50 and the first set of legs 55 rotate toward a vertical orientation, the second set of legs 60 may also rotate relative to the product support frame 50 and relative to the first set of legs 55. To allow for such rotation, the upper folding leg portions 65 may be pivotably coupled to the product support frame 50 using second pivot connections 105. The second pivot connections 105 may be positioned and located proximal to the second end 90 of the product support frame 50 and proximal to upper ends 110 of the upper folding leg portions 65. In addition to the second pivot connections 105, the lower folding leg portions 70 may be pivotably coupled to the first set of legs 55 using third pivot connections 115 (only one of which is illustrated in FIG. 5).

As the folding support mechanism 5 folds, lower ends 120 of the lower folding leg portions 70 may move towards the second end 90 of the product support frame 50. Because the upper folding leg portions 65 are coupled proximal to the second end 90 of the product support frame 50, the lower folding leg portions 70 may also move towards the upper ends 110 of the upper folding leg portions 65. As a result, the lower folding leg portions 70 may rotate relative to the upper folding leg portions 65 at inner pivot connections 125. More particularly, the upper folding leg portions 65 and the lower folding leg portions 70 may rotate towards an orientation where each are substantially parallel with one another. The inner pivot connections 125 may be positioned and located on the upper folding leg portions 65 opposite from the upper ends 110. Furthermore, the inner pivot connections 125 may be positioned and located on the lower folding leg portions 70 opposite from the lower ends 120. The second pivot connections 105, the third pivot connections 115, and the inner pivot connections 125 may be formed by pins, bolts, screws, or other similar connectors.

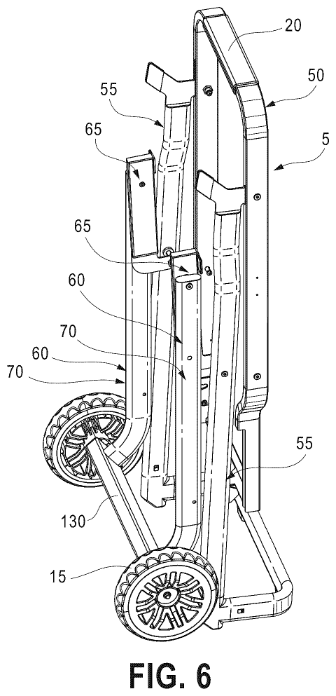

As a user continues to lift upwardly on the handle 20, as shown in FIG. 6, the folding support mechanism 5 will continue to fold until the product support frame 50, the first set of legs 55, and the second set of legs 60 are in a generally parallel configuration to one another. Once the product support frame 50, the first set of legs 55, and the second set of legs 60 are generally parallel, the upper folding leg portions 65 may be oriented parallel to the lower folding leg portions 70. More particularly, the upper folding leg portions 65 may extend in a direction opposite to the direction of the lower folding leg portions 70. At this point, the folding support mechanism 5 is in the folded position. From the folded position, the user may use the handle 20 to tilt the entire folding support mechanism 5 onto the wheels 15 for movement. The wheels 15 may be coupled to the folding support mechanism 5 through a lower cross member 130. The lower cross member 130 may be coupled to each of the lower folding leg portions 70. In some embodiments, the lower cross member 130 may be a hollow tubular structure configured to house an axle (not shown). The wheels 15 may be secured to the axle by screws, bolts, cotter pins, shaft collars, or similar connectors. In addition, bearings (not shown) may be provided on the lower cross member 130 to support and facilitate free rotation of the axle.

If a user wishes to transform the folding support mechanism 5 from a folded position to an unfolded position, he or she may repeat the previously described steps in a substantially reverse order.

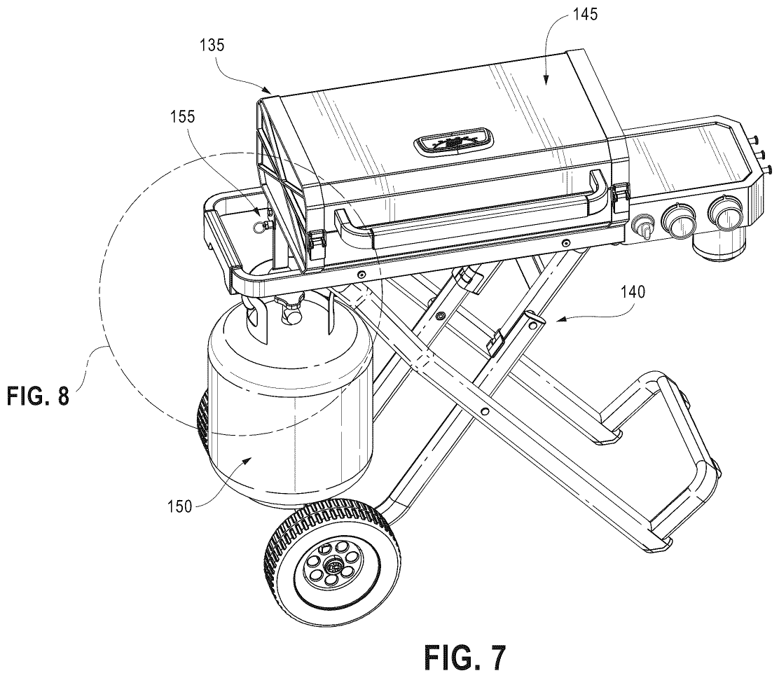

FIGS. 7-10 illustrate a second embodiment of a portable product 135. As shown in FIG. 7, the portable product 135 may include a folding support mechanism 140 and a product module 145. The folding support mechanism 140 and the product module 145 may be substantially similar to the folding support mechanism 5 and the product module 10 previously described. However, unlike the portable product 1 previously described, the portable product 135 may include a second fuel source 150. The second fuel source 150 may be coupled to the portable product 135 using a mounting mechanism 155. The second fuel source 150 may be a 20 lb. propane tank, though other fuel sources are foreseeable.

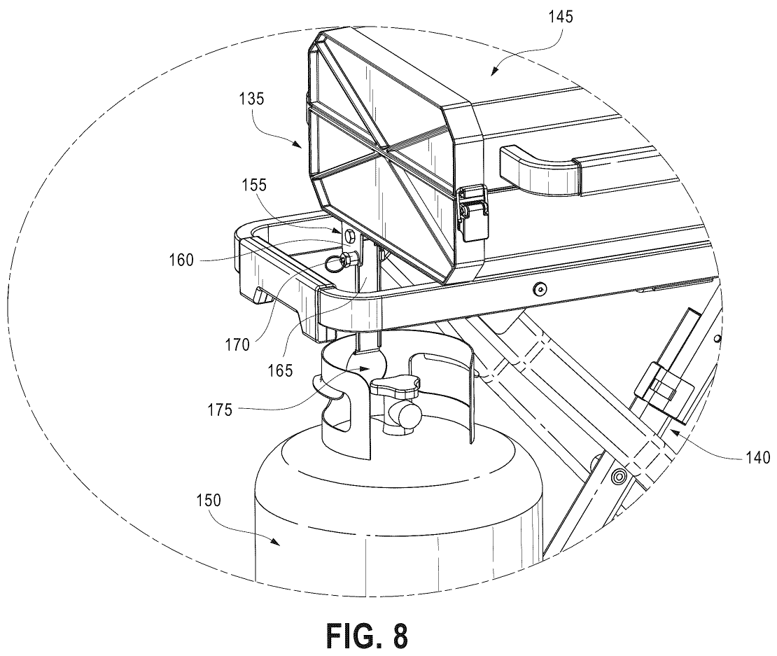

As illustrated in greater detail in FIG. 8, the mounting mechanism 155 may be coupled to the product module 145 of the portable product 135 via a mounting bracket 160 of the mounting mechanism 155. The mounting mechanism 155 may include a linkage member 165 selectively coupled to the mounting bracket 160 using a removable pin 170. The linkage member 165 may comprise a hook region (not shown) configured to be received by an aperture 175 positioned and located on the second fuel source 150. Prior to folding the folding support mechanism 140 for transportation or storage, a user may wish to decouple the second fuel source 150 from the portable product 135. In one instance, a user may decouple the second fuel source 150 by disengaging the mounting bracket 160 from the linkage member 165 by removing the removable pin 170. In another instance, the user may decouple the second fuel source 150 by lifting the second fuel source 150 off of the hook region of the linkage member 165. In addition, other mechanisms for selectively attaching and detaching the second fuel source 150 are foreseeable.

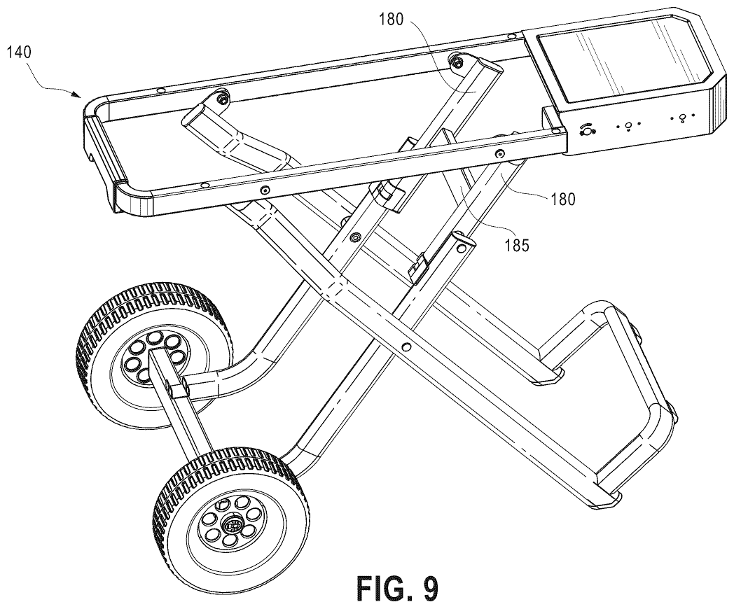

Turning to FIG. 9, the folding support mechanism 140 may include additional features not included in the folding support mechanism 5 previously described. For example, upper folding leg portions 180 may be provided with an upper cross member 185 configured to support and brace the upper folding leg portions 180. The upper cross member 185 may be a tubular steel or aluminum member with a substantially rectangular cross section. In alternative embodiments, the upper cross member 185 may be constructed from other materials (e.g., PVC) and may have any suitable cross-sectional shape.

In yet other embodiments of the present invention (not illustrated), a second set of legs may be configured to allow for a sliding relationship between lower folding leg portions and upper folding leg portions. The sliding relationship may allow for the upper folding leg portions to be slid toward or away from the lower folding leg portions when they are in alignment with one another. The sliding movement between the upper folding leg portions and the lower folding leg portions may be regulated by any suitable mechanisms (e.g., spring-loaded ball detents or thumbscrews) that selectively prevent sliding between the components. As a result, the overall length of the second set of legs may be selectively lengthened or shortened. This adjustment in the length of the second set of legs, in turn, may raise or lower the height of a product support frame and a product module to accommodate different heights or preferences of users.

An alternative embodiment may provide for a similar height adjustment for a product support frame by utilizing a different connection between a second set of legs and the product support frame. Rather than a fixed, pivoting connection between the second set of legs and the product support frame, a movable connection may be provided. For example, an upper portion of upper folding leg portions may be provided with multiple slots or notches along one side. The product support frame may be provided with one or more pins. To select a desired height for the product support frame and a product module, a user may selectively engage one of the pins of the product support frame with one of the slots or notches in the upper folding leg portions.

The embodiments of folding support mechanisms described herein allow for a user to move, fold, and unfold a folding support mechanism without having to significantly bend or reach down to do so. Thus, the folding support mechanisms described herein provide improved ergonomics and ease of use.

The preferred embodiments of the disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment but should be defined only in accordance with the following claims appended hereto and their equivalents.

What is claimed is:

1. A folding support mechanism for a portable product comprising:
a product support frame configured for a product module to be mounted on:
at least one first leg pivotably connected to the product support frame:
at least one second leg pivotably connected to the product support frame, the at least one second leg pivotably connected to the at least one first leg: and
wherein the at least one second leg comprises an upper folding leg portion and a lower folding leg portion, and wherein the upper folding leg portion and the lower folding leg portion are pivotably connected to one another such that the upper folding leg portion may rotate relative to the lower folding leg portion.

2. The folding support mechanism of claim 1, wherein a handle portion configured to be gripped by a user is positioned and located on the product support frame.

3. The folding support mechanism of claim 1, wherein the upper folding leg portion comprises at least one flange configured to abut the lower folding leg portion to limit rotation of the upper folding leg portion relative to the lower folding leg portion when the folding support mechanism is in an unfolded position . . .

4. The folding support mechanism of claim 1, wherein the lower folding leg portion comprises at least one flange configured to abut the upper folding leg portion to limit rotation of the upper folding leg portion relative to the lower folding leg portion when the folding support mechanism is in an unfolded position.

5. The folding support mechanism of claim 1, wherein the product module is a grill module.

6. The folding support mechanism of claim 1, wherein the product support frame is formed in a substantially rectangular shape with rounded corners.

7. The folding support mechanism of claim 1, wherein the folding support mechanism includes a plurality of wheels positioned and located on at least one of the at least one first leg and the at least one second leg, the plurality of wheels configured to assist a user with transporting the folding support mechanism.

8. The folding support mechanism of claim 1, wherein the at least one first leg is coupled to a foot member, and wherein the foot member is configured as a U-shaped member.

9. The folding support mechanism of claim 1, wherein the at least one first leg and the at least one second leg each comprise a tubular member with a rectangular cross section.

10. A folding support mechanism for a portable product having a folded position and an unfolded position, the folding support mechanism comprising:
a product support frame:
at least one first leg pivotably connected to the product support frame:
at least one second leg comprising an upper folding leg portion and a lower folding leg portion, the upper folding leg portion and the lower folding leg portion configured to rotate relative to one another:
wherein the upper folding leg portion is pivotably connected to the product support frame:
wherein the lower folding leg portion is pivotably connected to the at least one first leg:
wherein when the folding support mechanism is in the unfolded position, the upper folding leg portion is oriented substantially parallel to the lower folding leg portion, and the upper folding leg portion extends in a first direction substantially the same as a direction of the lower folding leg portion: and
wherein when the folding support mechanism is in the folded position, the upper folding leg portion is oriented substantially parallel to the lower folding leg portion, and the upper folding leg portion extends in a second direction substantially opposite of a direction of the lower folding leg portion.

11. The folding support mechanism of claim 10, wherein when the folding support mechanism is in the unfolded position, the product support frame is orientated substantially horizontally.

12. The folding support mechanism of claim 10, wherein when the folding support mechanism is in the unfolded position, the at least one first leg and the at least one second leg each support the product support frame.

13. The folding support mechanism of claim 10, wherein when the folding support mechanism is in the folded position, the product support frame and the at least one first leg are oriented substantially parallel to one another.

14. The folding support mechanism of claim 10, wherein when the folding support mechanism is in the folded position, a handle positioned and located on the product support frame is positioned proximal to an upper end of the folding support mechanism.

15. The folding support mechanism of claim 10 further comprising a foot member configured to support the folding support mechanism in an upright position when the folding support mechanism is in the folded position.

16. The folding support mechanism of claim 10, wherein the at least one first leg is coupled to a foot member configured to support the folding support mechanism in an upright position when the folding support mechanism is in the folded position.

17. The folding support mechanism of claim 10 further comprising at least one wheel and at least one standoff, wherein when the folding support mechanism is in the folded position, the folding support mechanism is configured to lie horizontally on a stable surface with the at least one standoff and the at least one wheel configured to abut the stable surface.

18. The folding support mechanism of claim 10 further comprising:
a lower cross member coupled to the at least one second leg; and
a plurality of wheels coupled to the lower cross member.

19. The folding support mechanism of claim 10, wherein the at least one first leg includes two first legs, and wherein the folding support mechanism includes at least one upper cross member that is coupled to the upper folding leg portion of each of the two first legs.

20. The folding support mechanism of claim 10 further comprising:
a product module coupled to the product support frame;
a mounting bracket coupled to the product module;
a linkage member configured to be selectively coupled to the mounting bracket; and
wherein the linkage member is configured to selectively receive an aperture in a fuel source.
